(19) United States
(12) Patent Application Publication
(10) Pub. No.: US 2025/0026380 A1
(43) Pub. Date: Jan. 23, 2025

(54) METHOD AND APPARATUS FOR PREDICTING FUTURE TRAJECTORIES OF NEARBY VEHICLES FOR AUTONOMOUS DRIVING

(71) Applicant: ELECTRONICS AND TELECOMMUNICATIONS RESEARCH INSTITUTE, Daejeon (KR)

(72) Inventors: Dooseop Choi, Daejeon (KR); Kyoung-Wook Min, Daejeon (KR)

(21) Appl. No.: 18/421,024

(22) Filed: Jan. 24, 2024

(30) Foreign Application Priority Data
Jul. 19, 2023 (KR) 10-2023-0093528
Oct. 20, 2023 (KR) 10-2023-0141326

(51) Int. Cl. B60W 60/00; B60W 50/00; G06N 3/0442; G06N 7/01

(52) U.S. Cl. CPC B60W 60/00274; B60W 50/0097; B60W 60/0011; G06N 3/0442; G06N 7/01; B60W 2552/53; B60W 2554/4041; B60W 2554/4045; B60W 2556/10; B60W 2556/40

(57) ABSTRACT

The present invention relates to a method and apparatus for predicting future trajectories of nearby vehicles for autonomous driving. The method of predicting the future trajectories of nearby vehicles according to the present invention includes generating past trajectories of the nearby vehicles, extracting local routes along which the nearby vehicles are travelable from a high-definition map, encoding the past trajectories and the local routes, and generating the future trajectories of the nearby vehicles using a deep neural network on the basis of the encoded past trajectories and an updated local route encoding.

### CROSS-REFERENCE TO RELATED APPLICATIONS

This application claims priority to and the benefit of Korean Patent Application No. 10-2023-0093528, filed on Jul. 19, 2023, and No. 10-2023-0141326, filed on Oct. 20, 2023, the disclosures of which are incorporated herein by reference in its entirety.

### BACKGROUND

### 1. Field of the Invention

The present invention relates to a method and apparatus for predicting future trajectories of vehicles around an autonomous driving car using an artificial neural network.

### 2. Description of Related Art

A typical autonomous driving system (ADS) drives a vehicle while performing the processes of recognition, determination, and control.

In the recognition process, the ADS uses data obtained from sensors, such as cameras, lidar, and the like, to find static and dynamic objects around the vehicle and track their locations. Further, the ADS recognizes lanes and nearby buildings, compares the recognized lanes and nearby buildings with those on a high-definition map (HD map), and then predicts a location and attitude of an autonomous driving car (hereinafter, referred to as “autonomous driving vehicle” or “autonomous car”).

In the determination process, the ADS generates multiple routes that fit the driving intention from results of the recognition and determines the degree of risk of each route to decide on one route. Lastly, in the control process, the ADS controls a steering angle and speed of the vehicle so that the vehicle can move along the route generated during the determination process.

In order to determine the degree of risk of each route in the determination process, it is essential to predict the future movement of nearby moving objects. For example, when an autonomous car changes lanes, the ADS should determine in advance whether there is a vehicle in the lane to which the autonomous car intends to move and whether the corresponding vehicle will cause a collision with the autonomous car in the future. To this end, it is very important to predict the future movement of the corresponding vehicle.

With the development of a deep neural network (DNN), many technologies for predicting the future trajectories of moving objects using a DNN have been proposed. In order to more accurately predict a future trajectory of a moving object, a DNN is designed to satisfy the following conditions (see FIGS. 1A to 1C).

Condition (1). A high-definition map or a driving environment image is used for the prediction of a future trajectory (see FIG. 1A).

Condition (2). Interactions between moving objects are considered for the prediction of a future trajectory (see FIG. 1B).

Condition (3). Ambiguity in the movement of a moving object is resolved by predicting multiple future trajectories per object (see FIG. 1C).

Condition (1) is applied to reflect the fact that vehicles mainly move along lanes and people move along paths such as sidewalks or the like. Condition (2) is applied to reflect the fact that the movement of an object is affected by the movement of other objects around the object. Condition (3) is applied to reflect the fact that a future location of an object follows a multimodal distribution due to the ambiguity of the object's movement intention.

Meanwhile, although many artificial neural networks have been proposed to satisfy Condition (3), a problem of predicted trajectories distributed in an area between center lines of adjacent lanes often occurs, as shown in FIG. 2. In the present invention, such a phenomenon is called mode blur. The center lines of lanes show a very high correlation with a mode of a future trajectory distribution of the vehicle. A phenomenon in which future trajectories are distributed between center lines of two adjacent lanes can be seen as occurring because the mode of future trajectory distribution is blurred.

FIGS. 3A and 3B are reference diagrams for describing the mode blur phenomenon. When a future trajectory distribution in FIG. 3A is compared with a future trajectory distribution in FIG. 3B, it can be seen that the mode blur phenomenon in FIG. 3B is more severe than that in FIG. 3A. Although, in both the distributions of FIGS. 3A and 3B, modes ma1, ma2, ma3, mb1, mb2, and mb3 of the distribution were formed on center lines r1, r2, and r3 of lanes, this is because the distribution in FIG. 3B has a greater probability of future trajectories present between the center lines of lanes than the distribution in FIG. 3A. There is a problem in that as mode blur in a distribution of future trajectories of nearby vehicles becomes more severe, it becomes more difficult to determine the degree of risk of each route for an autonomous driving vehicle.

### SUMMARY OF THE INVENTION

The present invention is directed to providing a deep neural network structure that can resolve mode blur in an artificial neural network for predicting future trajectories of vehicles around an autonomous driving car, and a training method and apparatus for the same. More specifically, the present invention is directed to providing a structure for an artificial neural network that predicts a plurality of future trajectories of nearby vehicles using past location records of nearby vehicles and a high-definition map, and a method and apparatus for effectively training the corresponding artificial neural network.

Objects of the present invention are not limited to the above-described objects and other objects of the present invention that are not described may be clearly understood by those skilled in the art from the following description.

According to an aspect of the present invention, there is provided a method of predicting future trajectories of nearby vehicles around an autonomous driving car, which includes generating, based on locations of one or more nearby vehicles, past trajectories of the nearby vehicles, extracting local routes along which the nearby vehicles are travelable from a high-definition map on the basis of current locations of the nearby vehicles, encoding the past trajectories and the local routes and generating a past trajectory encoding and a local route encoding, selecting a target vehicle from among the nearby vehicles, and updating a local route encoding of the target vehicle by reflecting a correlation between the target vehicle and a local route of the target vehicle and a correlation between the target vehicle and nearby vehicles around the target vehicle, and generating a future trajectory of the target vehicle on the basis of the past trajectory encoding and the updated local route encoding.

According to another aspect of the present invention, there is provided an apparatus for predicting future trajectories of nearby vehicles around an autonomous driving car, which includes a memory configured to store instructions readable by a computer, and at least one processor configured to execute the instructions.

The at least one processor may be configured to, by executing the instructions, generate, based on locations of one or more nearby vehicles, past trajectories of the nearby vehicles, extract local routes along which the nearby vehicles are travelable from a high-definition map on the basis of current locations of the nearby vehicles, encode the past trajectories and the local routes and generate a past trajectory encoding and a local route encoding, select a target vehicle from among the nearby vehicles, and update a local route encoding of the target vehicle by reflecting a correlation between the target vehicle and a local route of the target vehicle and a correlation between the target vehicle and nearby vehicles around the target vehicle, and generate a future trajectory of the target vehicle on the basis of the past trajectory encoding and the updated local route encoding.

According to an embodiment of the present invention, the future trajectories of moving objects around an autonomous driving vehicle can be more accurately predicted through DNN learning that minimizes mode blur.

FIGS. 4A and 4B are diagrams showing examples in which future trajectories of objects are predicted according to the present invention. In FIGS. 4A and 4B, gray circles and black circles represent past locations and actual future locations, respectively. Rainbow-colored quadrangles represent the locations of future trajectories generated by the proposed invention. Lastly, red solid lines represent the local routes that the objects can select, and gray solid lines represent the local routes that the objects cannot select. As shown in FIGS. 4A and 4B, it can be seen that a probability distribution of the future trajectories well reflect the shapes of the local routes.

Effects obtainable in the present invention are not limited to the above-described effects and other effects that are not described may be clearly understood by those skilled in the art from the above detailed descriptions.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A to 1C are diagrams for describing the conditions of a deep neural network (DNN) for accurately predicting a future trajectory of a moving object;

FIG. 2 is a diagram for describing a problem of predicted trajectories distributed in an area between center lines of adjacent lanes;

FIGS. 3A and 3B are reference diagrams for describing a mode blur phenomenon;

FIGS. 4A and 4B are diagrams showing examples in which future trajectories of objects are predicted according to the present invention;

FIG. 5 is a flowchart for describing a method of predicting future trajectories of nearby vehicles around an autonomous driving car according to an embodiment of the present invention;

FIG. 6 is a reference diagram for describing a process of extracting a local route from a high-definition map;

FIG. 7 is a flowchart for describing an operation of generating a local route for nearby vehicles around an autonomous driving car;

FIG. 8 is a diagram of an example in which local routes for nearby vehicles around an autonomous driving car are generated;

FIG. 9 is an exemplary diagram illustrating a tangent vector of a lane and a heading vector of a vehicle;

FIG. 10 is a flowchart for describing an operation of generating future trajectories of nearby vehicles around an autonomous driving car;

FIGS. 11A and 11B are reference diagrams for updating a local route encoding;

FIGS. 12A to 12C are reference diagrams for describing a calculation process required for data encoding and generating future trajectories for each vehicle; and

FIG. 13 is a block diagram illustrating a computer system for implementing the method of predicting the future trajectories according to the embodiment of the present invention.

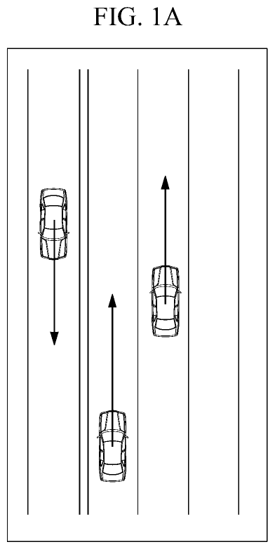

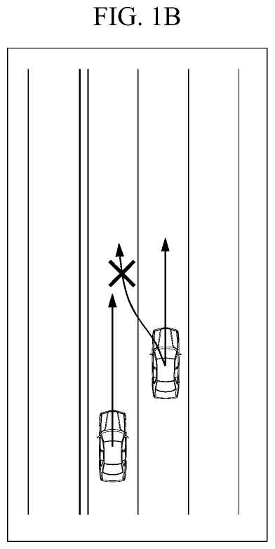

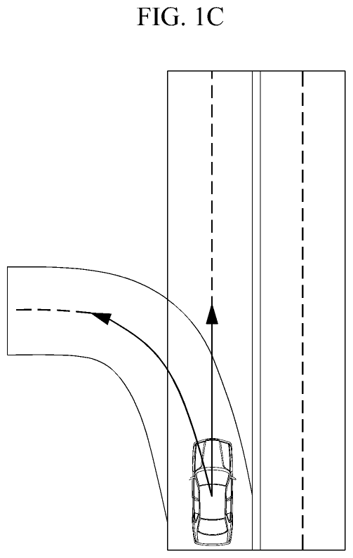

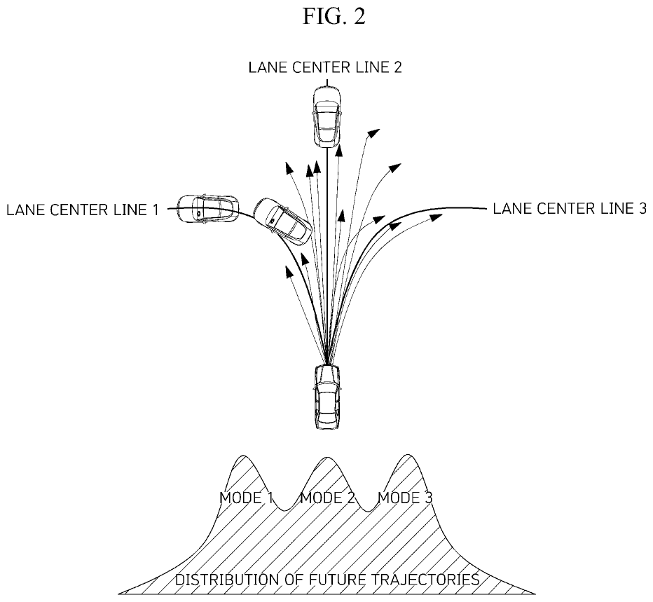

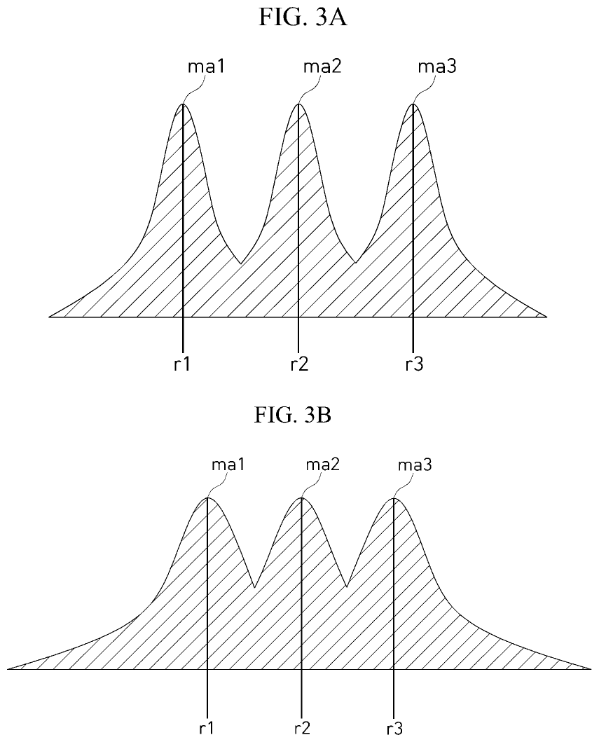

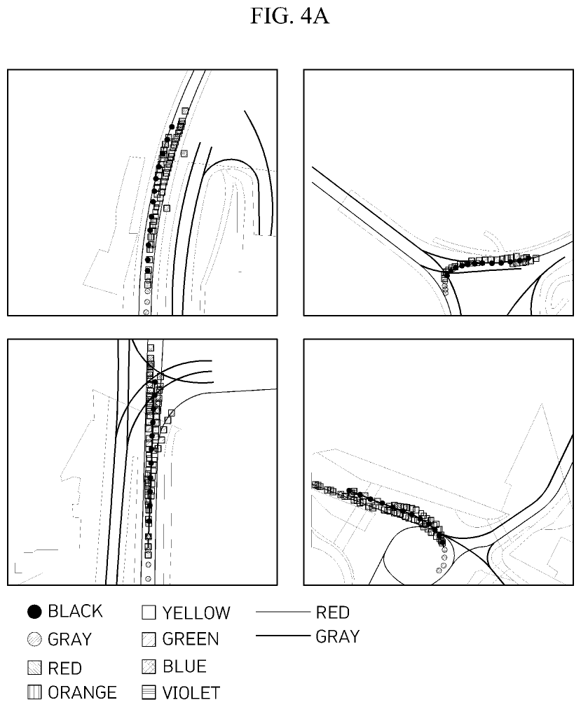

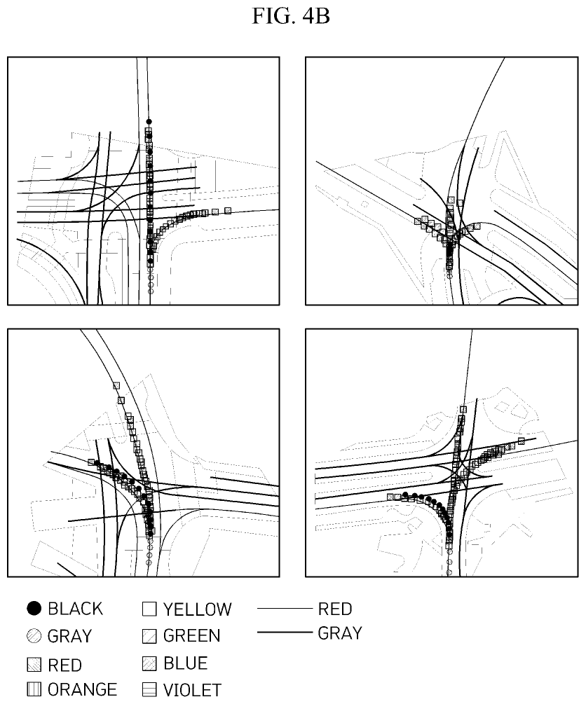

### DETAILED DESCRIPTION OF EXEMPLARY EMBODIMENTS

The present invention relates to a method and apparatus for training an artificial neural network to predict future trajectories of nearby vehicles around an autonomous driving car. More specifically, the present invention proposes a structure for an artificial neural network that predicts a plurality of future trajectories of nearby vehicles using past location records of the nearby vehicles and a high-definition map, and introduces several technologies for effectively training the corresponding artificial neural network.

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined only by the scope of the claims. Meanwhile, terms used herein are for the purpose of describing the embodiments and are not intended to limit the present invention. In this specification, the singular forms include the plural forms unless the context clearly indicates otherwise. It will be understood that the terms “comprise,” “comprising,” “include,” and/or “including” used herein specify some stated components, steps, operations and/or elements, but do not preclude the presence or addition of one or more other components, steps, operations and/or elements.

In description of the present invention, when it is determined that a detailed description of a related well-known function may unnecessarily obscure the gist of the present invention, the detailed description will be omitted.

Hereinafter, embodiments of the present invention will be described in detail with reference to the accompanying drawings. In description of the present invention, in order to facilitate overall understanding, like reference numerals are used for like elements even in different drawings.

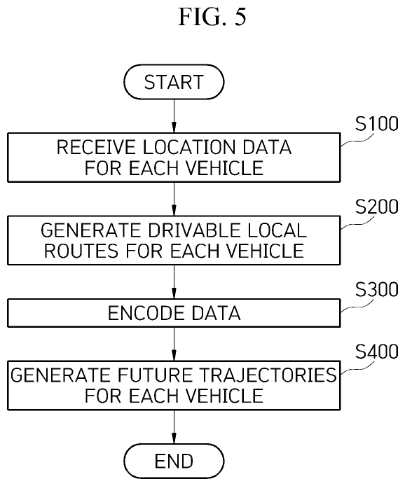

FIG. 5 is a flowchart for describing a method of predicting future trajectories of nearby vehicles around an autonomous driving car according to an embodiment of the present invention.

The method of predicting the future trajectories of nearby vehicles around the autonomous driving car (hereinafter, referred to as a “future trajectory prediction method”) illustrated in FIG. 5 consists of operations S100 to S400. The future trajectory prediction method illustrated in FIG. 5 is a method according to an embodiment, and the operations of the future trajectory prediction method according to the present invention are not limited to those of the embodiment illustrated in FIG. 5, and the operations may be changed or deleted and other operations may be added as necessary.

It is assumed that the future trajectory prediction method illustrated in FIG. 5 is performed by an apparatus 1000 for predicting future trajectories of nearby vehicles around an autonomous driving car according to an embodiment of the present invention (hereinafter, referred to as a “future trajectory prediction apparatus”). The future trajectory prediction apparatus 1000 may be mounted in an autonomous driving car or installed outside the autonomous driving car. In addition, although the present embodiment deals with a method and apparatus for predicting the future trajectories of vehicles around an autonomous car, it should be understood that the present invention may be applied to any moving object in addition to the vehicles around the autonomous car. However, for convenience of description, it is assumed that future trajectories of vehicles (hereinafter, referred to as “nearby vehicles” or “vehicles”) around an autonomous car are predicted.

The future trajectory prediction apparatus 1000 predicts the future trajectories of the vehicles around the autonomous car through a deep neural network (DNN) learning and inference. In the present embodiment, the DNN consists of four modules that are a data reception module, a local route generation module, a data encoding module, and a future trajectory generation module, and the four modules respectively correspond to operations S100 to S400 in FIG. 5. The future trajectory prediction apparatus 1000 executes each module of the DNN to perform operations S100 to S400.

Operation S100 is an operation of receiving location data for each vehicle. In this operation, the future trajectory prediction apparatus 1000 receives location data and attitude data of the vehicles around the autonomous car and stores and manages the received location data and attitude data for each vehicle. The future trajectory prediction apparatus 1000 receives the location data and attitude data of the vehicles around the autonomous car through sensors mounted on the autonomous car or through communication with an external source (e.g., another vehicle or computer system).

Operation S200 is an operation of generating drivable local routes for each vehicle. In this operation, the future trajectory prediction apparatus 1000 uses information on a current location and attitude of the vehicle to generate a local route (or lane center line information) along which the vehicle can travel from a high-definition map.

Operation S300 is an operation of encoding data. In this operation, the future trajectory prediction apparatus 1000 encodes the location data of the vehicle and the local routes.

Finally, operation S400 is an operation of generating future trajectories for each vehicle. In this operation, the future trajectory prediction apparatus 1000 predicts future trajectories for each vehicle for which data has been received.

Although the operations of the future trajectory prediction method according to the embodiment of the present invention illustrated in FIG. 5 are expressed as being performed sequentially, the future trajectory prediction apparatus 1000 may simultaneously perform the respective operations of the future trajectory prediction method through parallel processing.

Hereinafter, each operation of the future trajectory prediction method will be described in detail.

In operation S100, the future trajectory prediction apparatus 1000 detects or receives location data and attitude data for one or more nearby vehicles in real time and stores and manages the detected or received location data and attitude data for each vehicle. The attitude data includes heading angle data of the nearby vehicles.

The future trajectory prediction apparatus 1000 generates a past trajectory of the vehicle on the basis of the location data of the vehicle. A movement trajectory of a vehicle Aᵢ for the past T_{obs} seconds that the future trajectory prediction apparatus 1000 can obtain at a current time t is expressed as Xᵢ=[X_{(t-Hobs)}, . . . , xₜ]. Here, xₜ=[xₜ, yₜ] denotes a location of the vehicle Aᵢ at the time t. H_{obs}=T_{obs}*a sampling rate (Hz). When a total of N vehicles are detected at the current time t, [X₁, . . . , X_{N}] may be obtained.

In operation S200, the future trajectory prediction apparatus 1000 extracts drivable local routes for each vehicle from the high-definition map on the basis of the location and the heading angle of the vehicle at the current time.

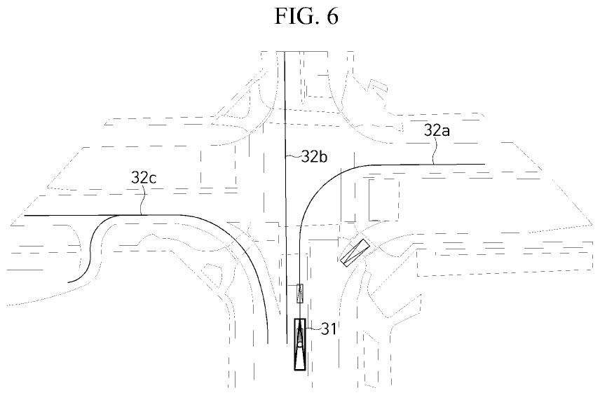

The future trajectory prediction apparatus 1000 extracts M local routes (or lane center lines) Lᵢ^{1:M} that may be selected by the vehicle using the location and the heading angle of the vehicle Aᵢ at the current time t, from the high-definition map. Here, Lᵢⁿ=[L₀, . . . , L_{P}] denotes an n^{th} local route among the M local routes and consists of a series of two-dimensional (2D) coordinate values Lₚ=[xₚ, yₚ]. FIG. 6 illustrates an example of the above description. FIG. 6 illustrates a target vehicle 31 and lane center lines 32a, 32b, and 32c around the target vehicle 31.

A lane center line of the high-definition map consists of consecutive segments, and one segment is defined by two coordinate values. Each segment has fixed start and end points and a vector direction defined by the two coordinate values. Segments within the same lane center line are connected to each other. When another segment B, which is connected to segment A, is ahead of segment A in a travelling direction of a lane, segment B is referred to as a leading segment of segment A, and conversely, segment A is referred to as a trailing segment of segment B.

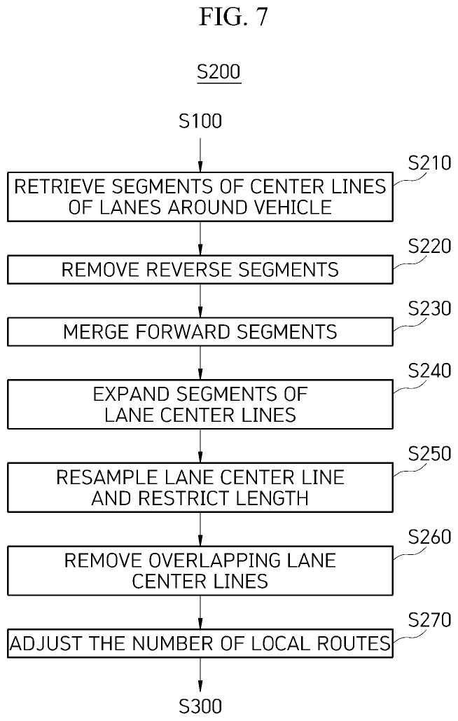

FIG. 7 is a flowchart for describing an operation of generating local routes for nearby vehicles around an autonomous driving car. As described above, operation S200 is an operation of retrieving local routes that the vehicle can select from the current location and the heading angle of the vehicle, and operation S200 can be subdivided and expressed as operations in the flowchart of FIG. 7. As illustrated in FIG. 7, in one embodiment of the present invention, operation S200 includes operations S210 to S270.

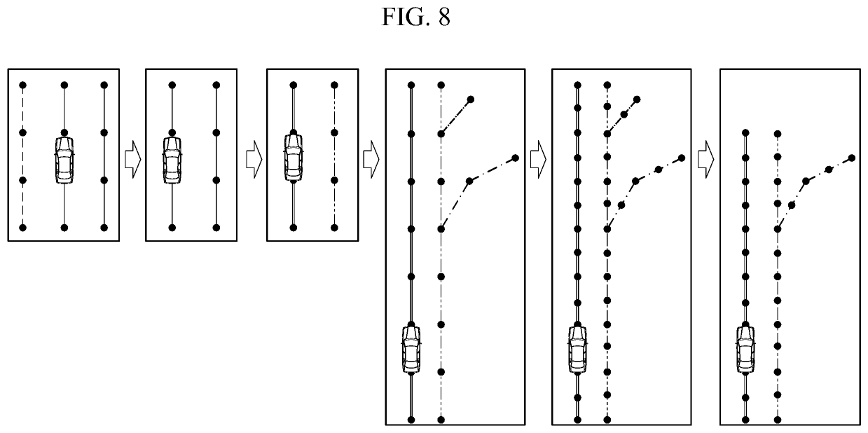

FIG. 8 is a diagram of an example in which local routes for nearby vehicles around an autonomous driving car are generated. In FIG. 8, a straight line connecting two consecutive points is one segment. Each point has coordinates values. First, the future trajectory prediction apparatus 1000 retrieves segments of center lines of all lanes within a radius of K meters around the autonomous car from a high-definition map (S210, retrieve segments of center lines of lanes around the vehicle). The radius K is a preset value. Next, the future trajectory prediction apparatus 1000 removes all segments in which an angle difference from a heading angle of the vehicle is greater than or equal to a certain value (S220, reverse segment removal). Next, the future trajectory prediction apparatus 1000 merges segments that are connected to each other among the remaining segments into one group (S230, forward segment merging). Next, the future trajectory prediction apparatus 1000 uses the segment connection information of the high-definition map to retrieve a segment that precedes and is connected to a segment within the segment group, and adds the retrieved segment to the corresponding group to generate a local route (S240, lane center line segment expansion). In this case, the segment expansion ensures that the sum of lengths of all segments within one group does not exceed a certain value. Next, the future trajectory prediction apparatus 1000 resamples all the segments connected within the group in specific length units and removes coordinate values that are greater than or equal to a certain distance so that all lane center lines have the same length (S250, lane center line resampling and length restriction). Then, overlapping center lines are removed (S260, removal of overlapping lane center lines).

Lastly, when the number of finally selected lane center lines (or local routes) is less than a specific value M, the future trajectory prediction apparatus 1000 adds a fake center line with all coordinate values of 0. Conversely, when the number of finally selected lane center lines is greater than M, the center lines are randomly removed so that the number of local routes for the corresponding vehicle becomes M (S270, adjustment of the number of local routes).

In operation S300, the future trajectory prediction apparatus 1000 encodes the location data of the vehicle and the local routes. The future trajectory prediction apparatus 1000 encodes data with continuous location coordinate values, such as a past trajectory {Xᵢ}, a correct future trajectory {Yᵢ}, and a local route {Lᵢ^{1:M}} of the vehicle, through a long short-term memory (LSTM) network to generate a past trajectory encoding, a correct future trajectory encoding, and a local route encoding. The correct future trajectory encoding is necessary for training a DNN.

Hereinafter, a method in which the future trajectory prediction apparatus 1000 encodes a trajectory of a vehicle and local routes will be described.

First, a method in which the future trajectory prediction apparatus 1000 encodes a trajectory of a vehicle will be described. The future trajectory prediction apparatus 1000 performs preprocessing before encoding a trajectory Xᵢ of a vehicle. The future trajectory prediction apparatus 1000 calculates a speed vₜ (units: m/s) and a heading hₜ (units: radians) of the vehicle at each pair of location coordinates xₜ=[xₜ, yₜ] and then adds the calculated speed and heading to a coordinate vector like xₜ=[xₜ, yₜ, vₜ, hₜ]. Then, the future trajectory prediction apparatus 1000 encodes the preprocessed Xᵢ using an LSTM network. A result of the encoding is defined as \tilde{X}ᵢϵR^{D}^{₁}. Even in the case in which a correct future trajectory Yᵢ is encoded for training, the future trajectory prediction apparatus 1000 performs preprocessing and encodes the correct future trajectory Yᵢ using the LSTM network, similar to the encoding of the vehicle trajectory. A result of the encoding is defined as \tilde{Y}ᵢϵR^{D}^{₁}.

Next, a method in which the future trajectory prediction apparatus 1000 encodes local routes will be described. The future trajectory prediction apparatus 1000 performs preprocessing before encoding an n^{th} local route Lᵢⁿ=[L₀, . . . , Lₚ] for an i^{th} vehicle. The future trajectory prediction apparatus 1000 calculates a tangent vector Vₚ=[vxₚ, vyₚ] and a direction vdₚ (units: radians) of the tangent vector at each pair of coordinates Lₚ=[xₚ, yₚ] and then adds the calculated tangent vector and direction of the tangent vector to a coordinate vector like Lₚ=[xₚ, yₚ, vxₚ, vyₚ, vdₚ]. Then, the future trajectory prediction apparatus 1000 encodes the preprocessed Lin using an LSTM network. A result of the encoding is defined as \tilde{L}ᵢⁿϵR^{D}^{₂}.

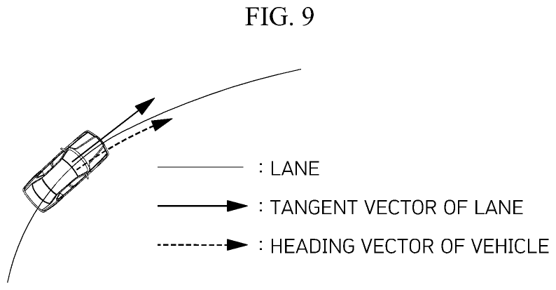

The reason for performing preprocessing of the vehicle trajectories and lane center lines in this way is that the direction of the vehicle is generally maintained parallel to the tangent vector of the lane center lines. FIG. 9 illustrates an example of the above description.

In operation S400, the future trajectory prediction apparatus 1000 predicts the future trajectories of vehicles around an autonomous car. The future trajectory prediction apparatus 1000 selects a target vehicle for predicting a future trajectory from among the vehicles around the autonomous car, updates the local route encoding of the target vehicle by reflecting a correlation between the target vehicle and a local route thereof and a correlation between the target vehicle and vehicles around the target vehicle, and generates a future trajectory of the target vehicle on the basis of the past trajectory encoding of the target vehicle and the updated local route encoding of the target vehicle.

In the present invention, the future trajectories of the nearby vehicles recognized by the autonomous car are predicted independently. Therefore, operation S400 may be performed simultaneously for each vehicle through parallel processing. Hereinafter, in describing operation S400 in detail, it is assumed that future trajectories are predicted using an i^{th} vehicle Aᵢ as a target vehicle for future trajectory prediction. Therefore, data required to predict the future trajectories includes 1) a past trajectory encoding \ddot{X}ᵢ, of the target vehicle, 2) a future trajectory encoding \tilde{Y}ᵢ, of the target vehicle (for training), 3) a past trajectory encoding {\ddot{X}ⱼ}_{j≠i} of nearby vehicles around the target vehicle, and 4) a local route encoding \ddot{L}ᵢ^{1:M}.

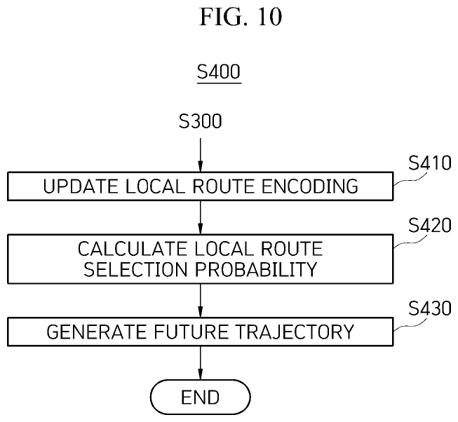

FIG. 10 is a flowchart for describing an operation of generating future trajectories of nearby vehicles around an autonomous driving car. As illustrated in FIG. 10, operation S400 includes operations S410 to S430.

Operation S410 is an operation of updating a local route encoding.

The future trajectory prediction apparatus 1000 updates the local route encoding of a target vehicle by reflecting an interaction between the target vehicle and a local route thereof and an interaction between the target vehicle and nearby vehicles around the target vehicle in the local route encoding of the target vehicle. When the future trajectory prediction apparatus 1000 predicts future trajectories using each local route or predicts the probability of moving to a specific local route, the future trajectory prediction apparatus 1000 updates a local route encoding \tilde{L}ᵢ^{1:M} to increase accuracy. For example, an n^{th} local route encoding \ddot{L}ᵢⁿ of an i^{th} vehicle is updated as shown in Equation 1.

$${\tilde{L}}_{i}^{n} = [ {α}_{n} ; {β}_{n} ] \qquad [ Equation 1 ]$$

Here, [;] denotes a concatenation operation. αₙϵR^{2×D}^{₂} denotes a vector reflecting an interaction between a vehicle Aᵢ and a local route \ddot{L}ᵢ^{1:M}. Next, βₙϵR^{D}^{₁} denotes a vector showing the representative movements of the nearby vehicles within a certain distance τ m or less from an n^{th} route Lᵢⁿ. First, αₙ is calculated as in Equation 2.

$${α}_{n} = [ {\tilde{L}}_{i}^{n} ; {\sum }_{m \neq n}^{M} {w}_{m} {\tilde{L}}_{i}^{m} ] \qquad [ Equation 2 ]$$

Here, wₘϵR¹ denotes a weight representing a correlation between a past trajectory encoding \ddot{X}ᵢ and a local route encoding \ddot{L}ᵢ^{1:M}, and satisfies

$${\sum }_{m = 1}^{M} {w}_{m} = 1.$$

For example, in a situation where the vehicle Aᵢ changes from an n^{th} lane to an m^{th} lane, a value of the weight wₘ will be close to 1 and remaining {wₖ}_{k≠m} values will be close to 0. Therefore, a local route encoding \tilde{L}ᵢⁿ that satisfies αₙ≈[\ddot{L}ᵢⁿ;\ddot{L}ᵢ^{m}] and is updated using Equation 1 can well express movements such as lane changes and the like when used in future trajectory prediction. The future trajectory prediction apparatus 1000 may obtain the weight wₘ through an attention operation between \tilde{X}ᵢ and \ddot{L}ᵢ^{1:M}.

Next, the future trajectory prediction apparatus 1000 first separately selects all nearby vehicles around the vehicle Aᵢ that are present at a predetermined distance τ or less from Lᵢⁿ in order to obtain βₙϵR^{D}^{₁}. It is assumed that the past trajectory encoding of the selected nearby vehicles is {\acute{X}ₒ}_{oϵN}_{ᵢ}. Here, Nᵢ denotes a set whose elements are indices of the selected nearby vehicles. Now, the future trajectory prediction apparatus 1000 updates the past trajectory encoding of the nearby vehicles using the past trajectory encoding \tilde{X}ᵢ and {\acute{X}ₒ}_{oϵN}_{ᵢ} of the vehicle Aᵢ. In this case, the update may be defined as self-attention or the like. That is, the future trajectory prediction apparatus 1000 may update the past trajectory encoding of the nearby vehicles around the target vehicle using a self-attention technique. βₙ is finally defined as Equation 3 using the updated past trajectory encoding.

$${β}_{n} = {\sum }_{o ∈ {N}_{i}} {\ddot{X}}_{o} \qquad [ Equation 3 ]$$

Therefore, the local route encoding Lᵢⁿ updated using Equation 1 includes information on the nearby vehicles that are present along the n^{th} local route, and eventually, when the future trajectories are predicted, interactions with the nearby vehicles may be reflected, and thus the accuracy of predicting future trajectories may be increased.

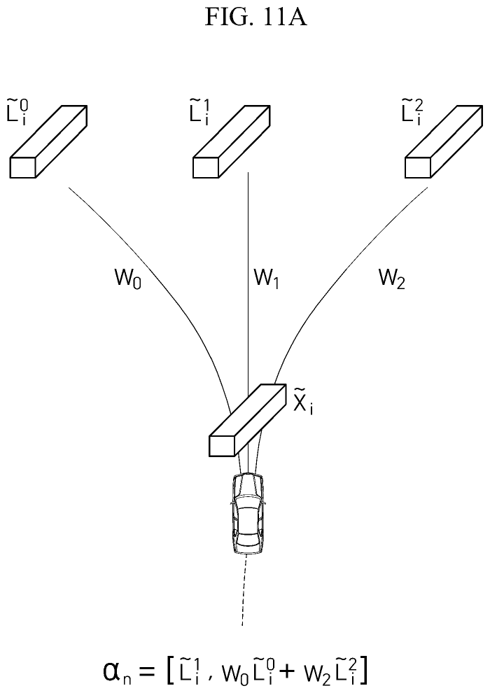

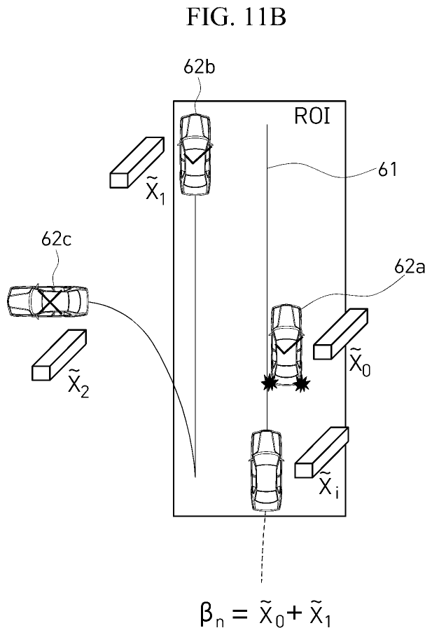

FIGS. 11A and 11B are diagrams for describing methods of calculating αₙ and βₙ, respectively. FIG. 11A shows a process of calculating an by reflecting a weight of each local route, and FIG. 11B shows a process of selecting a past trajectory encoding of vehicles 62a and 62b within a certain distance from a lane 61, updating the selected past trajectory encoding, and then calculating βₙ.

Referring to FIG. 10 again, operation S420 and subsequent operations will be described.

Operation S420 is an operation of calculating a local route selection probability. In this operation, the future trajectory prediction apparatus 1000 uses the updated local route encoding to calculate the probability that the target vehicle Aᵢ will select each local route. The future trajectory prediction apparatus 1000 generates a driving environment context vector representing a local route through a concatenation operation on the basis of the past trajectory encoding and updated local route encoding of the target vehicle. The driving environment context vector representing the n^{th} local route may be expressed as cᵢⁿ=[\tilde{X}′ᵢ:\tilde{L}ᵢⁿ] The future trajectory prediction apparatus 1000 may calculate a local route selection probability Pᵢ as shown in Equation 4 using a multi-layer perceptron (MLP) on the basis of the driving environment context vector.

$${P}_{i} = SOFTMAX ( MLP ( [ {c}_{i}^{1} , … , {c}_{i}^{M} ] ) ) , {P}_{i} ∈ {R}^{M} \qquad [ Equation 4 ]$$

Here, an n^{th} element value of the local route selection probability Pᵢ is the probability that the vehicle Aᵢ will select the n^{th} local route.

Operation S430 is an operation of generating a future trajectory of a target vehicle. The future trajectory prediction apparatus 1000 generates a future trajectory of the target vehicle by reflecting the local route selection probability on the basis of the past trajectory encoding of the target vehicle and the updated local route encoding of the target vehicle.

The future trajectory prediction apparatus 1000 independently generates a future trajectory from each local route. In this case, the future trajectory prediction apparatus 1000 determines the number of future trajectories generated based on each local route in proportion to the probability Pᵢ(n) that the corresponding local route will be selected. For example, it is assumed that 100 future trajectories are generated for the vehicle Aᵢ. Further, it is assumed that Pᵢ(1)=0.9, Pᵢ(2)=0.1, and Pᵢ(2)= . . . =Pᵢ(M)=0. In this case, the future trajectory prediction apparatus 1000 generates 90 future trajectories from a driving environment context vector cᵢ¹ corresponding to a local route Lᵢ¹ and generates 10 future trajectories from a driving environment context vector cᵢ² corresponding to a local route Lᵢ². No future trajectories are generated from the remaining local routes.

When the future trajectory prediction apparatus 1000 generates future trajectories using a driving environment context vector cᵢⁿ, the future trajectory prediction apparatus 1000 may use a method in which a latent variable, such as a variational autoencoder (VAE) or a generative adversarial network (GAN), is used.

When a VAE is used, the future trajectory prediction apparatus 1000 may calculate as follows. First, two artificial neural networks MLPₚₒₛₜ and MLPₚᵣᵢₒᵣ are defined. Usually, MLPₚₒₛₜ is called a recognizer network and MLPₚᵣᵢₒᵣ is called a prior network. Each network generates a mean vector μϵR^{D}^{₃} and a standard deviation vector σϵR^{D}^{₃} of a Gaussian probability distribution as shown in Equations 5 and 6.

$$\begin{matrix}{μ}_{post} , {σ}_{post} = {MLP}_{post} ( [ {\ddot{Y}}_{i} ; {c}_{i}^{n} ] ) & [ Equation 5 ] \\ {μ}_{prior} , {σ}_{prior} = {MLP}_{prior} ( {c}_{i}^{n} ) & [ Equation 6 ]\end{matrix}$$

MLPₚₒₛₜ is used when training a DNN, and as shown in Equation 5, not only the driving environment context vector, but also a correct future trajectory encoding \tilde{Y}ᵢ is input, and the mean vector and the standard deviation vector of the Gaussian probability distribution are generated. MLPₚᵣᵢₒᵣ is used for the prediction of the future trajectories, and as shown in Equation 6, the driving environment context vector is input, and a mean vector and a standard deviation vector of a Gaussian probability distribution are generated.

Each of the mean vector and the standard deviation vector is used to generate Gaussian random vectors zₚₒₛₜϵR^{D}^{₃} and zₚᵣᵢₒᵣϵR^{D}^{₃}. A random vector z together with cᵢⁿ is used to generate a future trajectory in which Aᵢ travels the n^{th} local route, and may be implemented as Equation 7. That is, the future trajectory prediction apparatus 1000 generates the future trajectory of the target vehicle using an MLP decoder on the basis of the Gaussian random vectors and the driving environment context vector.

$${\hat{Y}}_{i} = {MLP}_{decoder} ( [ z ; {c}_{i}^{n} ] ) \qquad [ Equation 7 ]$$

The future trajectory prediction apparatus 1000 extracts Gaussian random vectors for each local route from the Gaussian probability distribution defined by the mean vector and standard deviation vector generated by Equation 5 or 6. In this case, the future trajectory prediction apparatus 1000 may determine the number of random vectors to be extracted in proportion to the local route selection probability. That is, the future trajectory prediction apparatus 1000 generates the Gaussian random vectors by reflecting the local route selection probability on the basis of the mean vector and standard deviation vector of the Gaussian probability distribution. Since as many future trajectories as the number of random vectors are generated, the number of future trajectories generated based on each local route is determined in proportion to the probability Pᵢ(n) that the corresponding local route will be selected.

The future trajectory prediction apparatus 1000 generates different random vectors and then generates the future trajectories using Equation 7, and thus the same effect as sampling the future trajectories from modes of the probability distribution of the predicted future trajectories (modes of a probability distribution corresponding to the local route Lᵢⁿ) may be obtained.

In addition, in an artificial neural network learning process proposed in the present invention, future trajectories are generated using zₚₒₛₜ, and in a test process, future trajectories are generated using zₚᵣᵢₒᵣ.

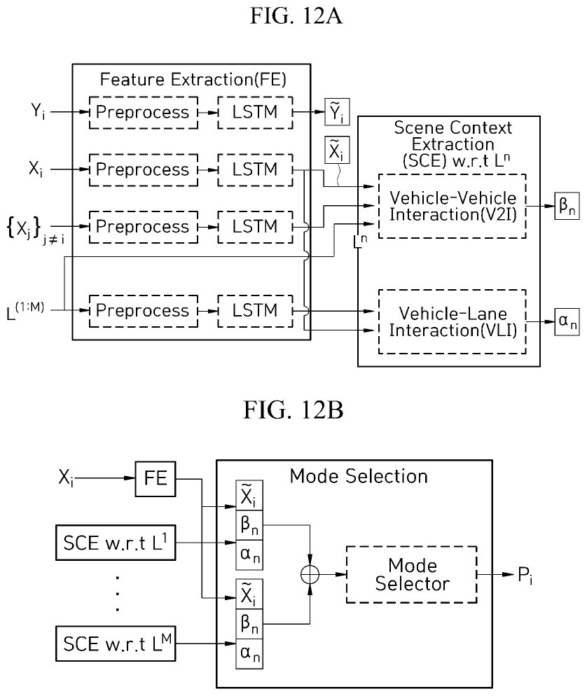

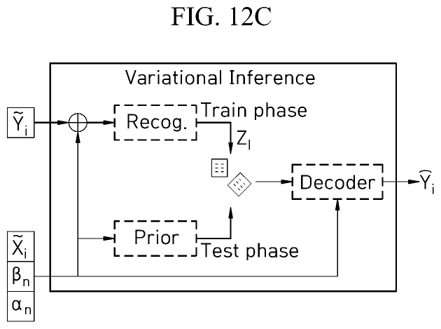

FIGS. 12A to 12C are reference diagrams for describing a calculation process required for data encoding and generating future trajectories for each vehicle. FIGS. 12A to 12C summarize and show the entire process for generating future trajectories.

“Feature Extraction (FE)” in FIG. 12A corresponds to a data encoding. “Scene Context Extraction (SCE)” shows a process of updating \tilde{L}ⁿ through local route encoding updating. For reference, \tilde{L}ⁿ updated according to Equation 1 is the same as [αₙ;βₙ]. FIG. 12B shows a process of calculating a local route selection probability. FIG. 12C shows a process of generating a future trajectory from cⁿ=[\tilde{X}; \tilde{L}ⁿ] and a random variable z.

Hereinafter, a method in which the future trajectory prediction apparatus 1000 trains a DNN for future trajectory prediction will be described.

The future trajectory prediction apparatus 1000 trains the DNN so that an evidence lower bound (ELBO) is minimized. Equation 8 represents an ELBO loss function (ELBO loss).

$${L}_{ELBO} = {‖ Y - \hat{Y} ‖}^{2} + β KL ( Q \vert \vert P ) \qquad [ Equation 8 ]$$

Here, β is an arbitrary constant and KL (∥) denotes Kullback-Leibler divergence (KLD). Q and P denote Gaussian distributions defined by outputs μ and σ of a recognizer network and prior network, respectively.

Further, the future trajectory prediction apparatus 1000 induces the DNN to learn the probability that the vehicle will select a specific local route, and the future trajectory prediction apparatus 1000 induces the DNN to learn the local route selection probability so that a binary cross entropy loss function as shown in Equation 9 is minimized.

$${L}_{BCE} = BCE ( {P}_{i} , \hat{P} ) \qquad [ Equation 9 ]$$

Here, Pᵢ is a predicted value of the probability that a vehicle Aᵢ will select each local route, and is defined by Equation 4. P̅ is a correct one-hot vector, and denotes a vector where a local route index that the vehicle Aᵢ has actually moved on at a future time point is 1 and the remaining indexes are 0. For example, when the vehicle Aᵢ moves to a second local route at the future time point, \ddot{P}(2)=1, \ddot{P}(1)=\ddot{P}(3)= . . . =\ddot{P}(M)=0.

Therefore, a loss that the future trajectory prediction apparatus 1000 should finally minimize for training a DNN is defined as Equation 10.

$${L}_{total} = {L}_{ELBO} + λ {L}_{BCE} \qquad [ Equation 10 ]$$

Here, λ is an arbitrary constant.

The above-described future trajectory prediction method has been described with reference to the flowcharts illustrated in the drawings. For simplicity of description, the method has been illustrated and described as a series of blocks, but the present invention is not limited to the order of the blocks. Some blocks may occur simultaneously or in a different order than shown and described herein with other blocks, and various other branches, flow paths, and sequences of blocks that achieve the same or similar results may be implemented. Further, not all blocks shown may be required for implementation of the methods described herein.

Meanwhile, in the description referring to FIGS. 5 to 12C, each operation may be further divided into additional operations or the operations may be combined into fewer operations, depending on the implementation of the present invention. Further, some operations may be omitted or the order between the operations may be changed as necessary.

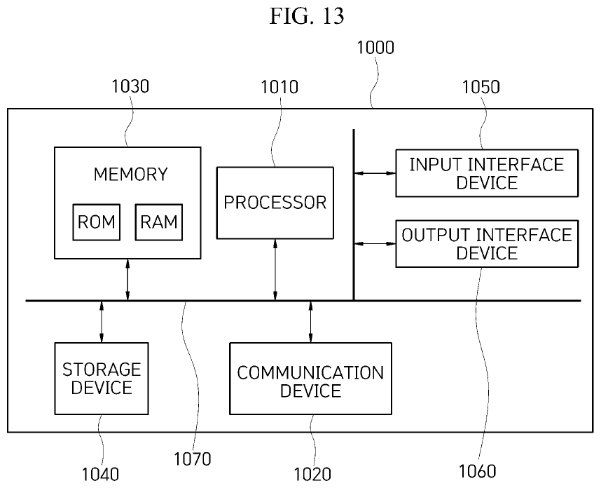

FIG. 13 is a block diagram illustrating a computer system for implementing the method of predicting the future trajectories according to the embodiment of the present invention. The future trajectory prediction apparatus 1000 may be implemented in the form of the computer system of FIG. 13.

Referring to FIG. 13, the computer system 1000 may include at least one of a processor 1010, a memory 1030, an input interface device 1050, an output interface device 1060, and a storage device 1040 that communicate through a bus 1070. The computer system 1000 may further include a communication device 1020 coupled to a network. The processor 1010 may be a central processing unit (CPU) or a semiconductor device that executes instructions stored in the memory 1030 or storage device 1040. The memory 1030 and the storage device 1040 may include various types of volatile or non-volatile storage media. For example, the memory 1030 may include a read-only memory (ROM) and a random access memory (RAM). In the embodiments of the present invention, the memory 1030 may be located inside or outside the processor 1010, and the memory 1030 may be connected to the processor 1010 through various known devices. The memory 1030 may include any of various types of volatile or non-volatile storage media, for example, the memory 1030 may include an ROM or an RAM.

Therefore, the embodiments of the present invention may be implemented as a computer-implemented method or as a non-transitory computer-readable medium in which computer-executable instructions are stored. In one embodiment, when executed by the processor, the computer-readable instructions may perform the method according to at least one aspect of the present invention.

The communication device 1020 may transmit or receive wired signals or wireless signals.

Further, the method according to the embodiment of the present invention may be implemented in the form of program instructions that can be executed through various computer devices, and recorded on computer-readable media.

The computer-readable media may include program instructions, data files, data structures, or combinations thereof. The program instructions recorded on the computer-readable media may be specially designed and configured for the embodiments of the invention or may be instructions known and usable by those skilled in the field of computer software. The computer-readable media may include a hardware device that is configured to store and perform the program instructions. Examples of the computer-readable media include magnetic media such as a hard disk, a floppy disk, and a magnetic tape, optical media such as a compact disc read-only memory (CD-ROM) and a digital video disc (DVD), magneto-optical media such as a floptical disk, a ROM, a RAM, a flash memory, etc. Examples of the program instruction include machine code generated by a compiler and high-level language code that can be executed by a computer using an interpreter and the like.

Meanwhile, the content of FIGS. 5 to 12C may be applied to the content of FIG. 13. For example, the processor 1010 performs the calculations and operations shown as being performed by the future trajectory prediction apparatus 1000 in FIGS. 5 to 12C, and the memory 1030 and the storage device 1040 are configured to store data and information collected from the outside or generated through calculations.

Further, the content of FIG. 13 may be applied to the content of FIGS. 5 to 12C.

While exemplary embodiments of the present invention and their advantages have been described above in detail, it should be understood that various changes, substitutions and alterations may be made herein without departing from the scope of the present invention as defined by the following claims.

What is claimed is:

1. A method of predicting future trajectories of nearby vehicles around an autonomous driving car, comprising:
generating, based on locations of one or more nearby vehicles, past trajectories of the nearby vehicles;
extracting local routes along which the nearby vehicles are travelable from a high-definition map on the basis of current locations of the nearby vehicles;
encoding the past trajectories and the local routes and generating a past trajectory encoding and a local route encoding;
selecting a target vehicle from among the nearby vehicles, and updating a local route encoding of the target vehicle by reflecting a correlation between the target vehicle and a local route of the target vehicle and a correlation between the target vehicle and nearby vehicles around the target vehicle; and
generating a future trajectory of the target vehicle on the basis of the past trajectory encoding and the updated local route encoding.

2. The method of claim 1, wherein, in the extracting of the local routes, the local routes are extracted from the high-definition map on the basis of the current locations of the nearby vehicles and heading angles of the nearby vehicles.

3. The method of claim 1, wherein, in the generating of the past trajectory encoding and the local route encoding, the past trajectories and the local routes are encoded using a long short-term memory (LSTM) and the past trajectory encoding and the local route encoding are generated.

4. The method of claim 2, wherein the extracting of the local routes includes:
retrieving segments of center lines of lanes within a predetermined radius around the autonomous car on the high-definition map;
removing a segment whose angle difference from the heading angle is greater than or equal to a certain value from among the retrieved segments;
merging segments connected to each other among remaining segments into a group; and
retrieving preceding segments of the segments belonging to the group, adding the retrieved preceding segments to the corresponding group, and generating the local routes.

5. The method of claim 1, wherein the generating of the future trajectory includes:
concatenating the past trajectory encoding and the updated local route encoding and generating a driving environment context vector;
inputting the driving environment context vector into a pre-trained prior network composed of a multilayer perceptron (MLP) and generating a mean vector and a standard deviation vector of a Gaussian probability distribution;
generating a random vector using the mean vector and the standard deviation vector; and
inputting the random vector and the driving environment context vector into a decoder composed of an MLP and generating the future trajectory.

6. The method of claim 5, further comprising calculating a local route selection probability on the basis of the driving environment context vector,
wherein, in the generating of the random vector, the random vector is generated for each local route by applying the local route selection probability.

7. An apparatus for predicting future trajectories of nearby vehicles around an autonomous driving car, comprising:
a memory configured to store instructions readable by a computer; and
at least one processor configured to execute the instructions,
wherein the at least one processor is configured to execute the instructions so as to:
generate, based on locations of one or more nearby vehicles, past trajectories of the nearby vehicles;
extract local routes along which the nearby vehicles are travelable from a high-definition map on the basis of current locations of the nearby vehicles;
encode the past trajectories and the local routes and generate a past trajectory encoding and a local route encoding;
select a target vehicle from among the nearby vehicles, and update a local route encoding of the target vehicle by reflecting a correlation between the target vehicle and a local route of the target vehicle and a correlation between the target vehicle and nearby vehicles around the target vehicle; and
generate a future trajectory of the target vehicle on the basis of the past trajectory encoding and the updated local route encoding.

8. The apparatus of claim 7, wherein the at least one processor is configured to extract the local routes from the high-definition map on the basis of the current locations of the nearby vehicles and heading angles of the nearby vehicles.

9. The apparatus of claim 7, wherein the at least one processor is configured to encode the past trajectories and the local routes using a long short-term memory (LSTM) and generate the past trajectory encoding and the local route encoding.

10. The apparatus of claim 8, wherein the at least one processor is configured to:
retrieve segments of center lines of lanes within a predetermined radius around the autonomous car on the high-definition map;
remove a segment whose angle difference from the heading angle is greater than or equal to a certain value from among the retrieved segments;
merge segments connected to each other among remaining segments into a group; and
retrieve preceding segments of the segments belonging to the group, add the retrieved preceding segments to the corresponding group, and generate the local routes.

11. The apparatus of claim 7, wherein the at least one processor is configured to:
concatenate the past trajectory encoding and the updated local route encoding and generate a driving environment context vector;
input the driving environment context vector into a pre-trained prior network composed of a multilayer perceptron (MLP) and generate a mean vector and a standard deviation vector of a Gaussian probability distribution;
generate a random vector using the mean vector and the standard deviation vector; and
input the random vector and the driving environment context vector into a decoder composed of an MLP and generate the future trajectory.

12. The apparatus of claim 11, wherein the at least one processor is configured to:
calculate a local route selection probability on the basis of the driving environment context vector; and
generate the random vector for each local route by applying the local route selection probability.
